(19) United States
(12) Patent Application Publication
(10) Pub. No.: US 2015/0251800 A1
(43) Pub. Date: Sep. 10, 2015

(54) CANDLE HOLDER BOX

(71) Applicants: RYAN FISHER, HOOPER, UT (US); AUSTIN BIDEAUX, ROY, UT (US); DARRELL MYERS, LAYTON, UT (US)

(72) Inventors: RYAN FISHER, HOOPER, UT (US); AUSTIN BIDEAUX, ROY, UT (US); DARRELL MYERS, LAYTON, UT (US)

(21) Appl. No.: 14/641,386

(22) Filed: Mar. 7, 2015

Related U.S. Application Data
(60) Provisional application No. 61/949,250, filed on Mar. 7, 2014.

(51) Int. Cl. B65D 5/52; F21V 35/00

(52) U.S. Cl. CPC B65D 5/5286; F21V 35/003

(57) ABSTRACT

A therapeutic candle kit comprising a boxlike storage container, typically several inches in length, fabricated from resilient biodegradable material, reconfigurable and reusable as a candle holder, together with therapeutic candles. In one implementation, a manufacturer can provide in a side of the box a hole that, when the box is disassembled, can serve as a candle holder to retain a candle and protect the user while in use, and before disposal. In another implementation, the box can be constructed to be non-destructively reconfigured as a candle holder and following use the box can be restored to use as a storage container for remaining candles.

### CROSS-REFERENCE TO RELATED APPLICATIONS

This application claims the benefit of U.S. Provisional Application No. 61/949,250, filed Mar. 7, 2014.

### BACKGROUND OF THE INVENTION

1. The Field of the Invention

Implementations of the present invention relate to packaging for candles and a system for administering therapeutic candles.

2. Background and Relevant Art

Candles are sold in a variety of sizes and shapes, and for a multitude of purposes. Many scented and decorative candles are sold preassembled in a jar or other flame resistant functional container, or sold loose to be placed on or in a candle holder or container of some type.

Candles of a utilitarian type are often sold in bulk, by the bag or boxed for use in emergency for heat or light, or for religious worship, celebration, memorial services and therapeutic applications. The packages for such candles are, with rare exception, not usable in any functional way other than as storage containers. None are available as therapeutic candle kits.

Some therapeutic candles are made by rolling a thin sheet of wax into a hollow, cylindrical, and wickless candle. Such candles may also be formed by coating a fabric or other flexible substrate with a candle wax and rolling the coated sheet to form the hollow candle. It is desirable to exercise special care to protect these light-weight hollow, wickless candles when lighting and while in use and storage. Further, the use of therapeutic candles requires the constant attendance of the user reducing the need for durable candle holders such as those used with other types of candles that are frequently left unattended.

Therapeutic candles are frequently used in close proximity to the user, including by placing the unlit end in contact with the user where ash or melted wax may fall and come in contact with the user.

These therapeutic candles may be made of any typical candle wax including paraffin and beeswax.

What is needed is a candle package that is capable of protecting and displaying candles while in the marketing sales channel and through use of the candles, but also capable of holding the candles while in use, including as a safety measure to protect the user from falling ash or melted wax descending the outside of the candle. It is also desirable for the candle holder to be capable of reuse in the case of a kit containing multiple candles. It is a further object of the candle holder to be recyclable and biodegradable for environmentally friendly disposal.

### BRIEF SUMMARY OF THE INVENTION

Implementations of the present invention provide a packaging article configured to serve the typical function of containing and protecting therapeutic candles during shipment, while on display, or in storage. Implementations of the present invention will also provide a reconfigurable construction that permits the package, in the form of a box, to also hold a therapeutic candle and protect its user while in use. Implementations of the present invention are reusable and, when the candles are consumed, may be recycled or discarded as biodegradable waste. Implementations of the present invention may optionally possess flame retardant properties.

In one implementation of the present invention, for example, a manufacturer fabricates a folded container in the form of an elongated box having at least three long sides. At least one long sidewall of the box is punched, perforated or cut to retain a therapeutic candle in the hole created or facilitated by the punch, perforation or cut. When in use, the therapeutic candle, or candles are removed from the box. The box may be deconstructed to lie relatively flat and the candle inserted into the retaining hole to stand in a generally vertical position.

When inserted into the box, the candle is held securely to be safely lit and used by the consumer. During use, the deconstructed candle holder box serves as a shield protecting the user from falling ash or melted wax. Following use, the box can be reconstructed and any remaining candles can be optionally restored to the box and returned to storage.

In another implementation of the present invention, the side walls of the box may be scored or creased to facilitate deformative folding, such as through compression of the box, to alter the shape of the box in a non-destructive way for use as a candle holder. Such deformation may be desirable to alter the center of gravity or weight distribution, or to increase the area of the base of the box when functioning as a candle holder while preserving the structural integrity for reuse as a storage container for unused candles.

In a further implementation of the present invention, additional holes may be provided to accommodate additional candles simultaneously. Alternatively, additional holes may be provided in the same side, or in sides opposite or adjacent the side of a first hole to allow the candle in use to be retained by piercing the box in two locations or two sides of the box during use. By varying the depth of the candle retained by and penetrating through the box, the consumer can adjust the angle at which the candle is held, relative to the surface on which the box and the protruding bottom of the candle rest. Optionally, the box may be held and used to direct the placement or position of the therapeutic candle.

In another implementation of the present invention, the box is made of a resilient biodegradable material that may be repeatedly restored to a boxlike candle storage container following use as a candle holder until, when all the candles are consumed, it is capable of environmentally friendly disposal.

In yet another implementation of the present invention, the box described herein can also be made to possess fire resistance properties by selecting fire resistant starting materials to form the boxes, or by chemically treating such starting materials, such as may be desired by the consumer or required by consumer protection codes.

Accordingly, implementations of the present invention provide a number of advantages to consumers of therapeutic candles. Additional features and advantages of exemplary implementations of the invention will be set forth in the description which follows, and in part will be obvious from the description, or may be learned by the practice of such exemplary implementations. The features and advantages of such implementations may be realized and obtained by means particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exploded perspective view of a candle holder box with four therapeutic candles oriented to be inserted into and received by the candle holder box of the present invention during packaging;

FIG. 2 illustrates a schematic drawing of a candle holder box of the present invention prior to folding and construction of the cut sheet material into a container of the present invention; and

FIG. 3 illustrates a perspective view of the deconstructed candle holder box with a therapeutic candle inserted in a hole in the side thereof, wherein the box is flattened to be used as a shield or tray to capture any ash from the burning candle.

FIG. 4 illustrates a perspective view of the candle holder box intact with a therapeutic candle inserted and retained in one side thereof.

### DETAILED DESCRIPTION OF THE PREFERRED EMBODIMENTS

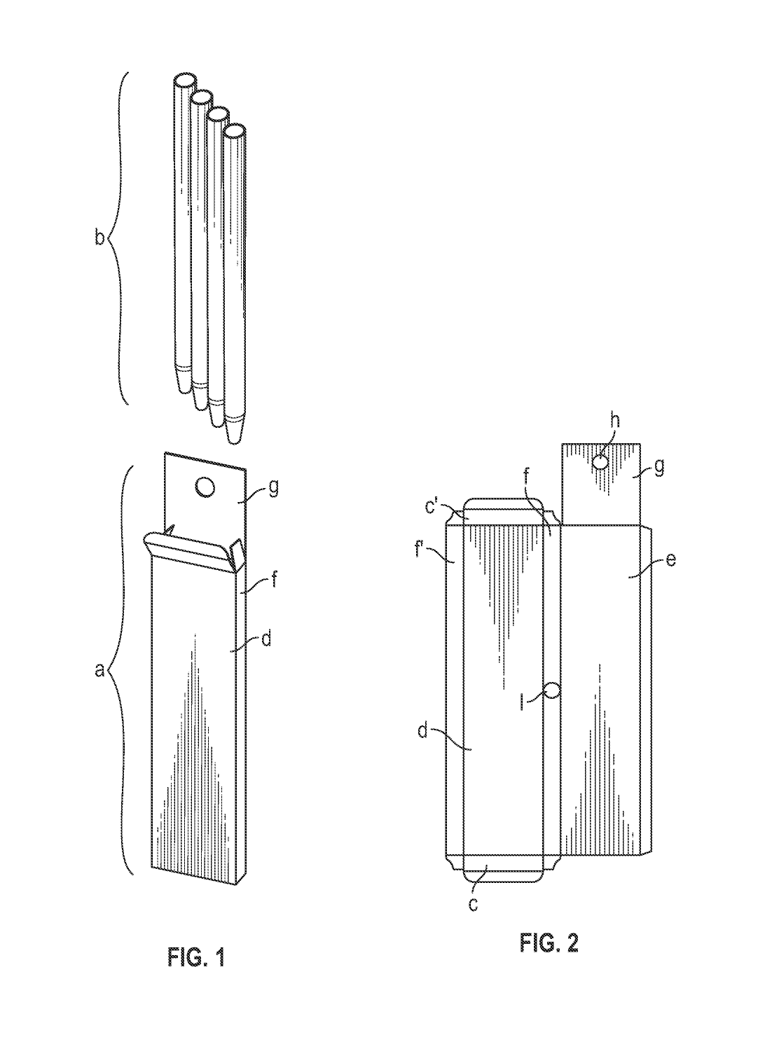

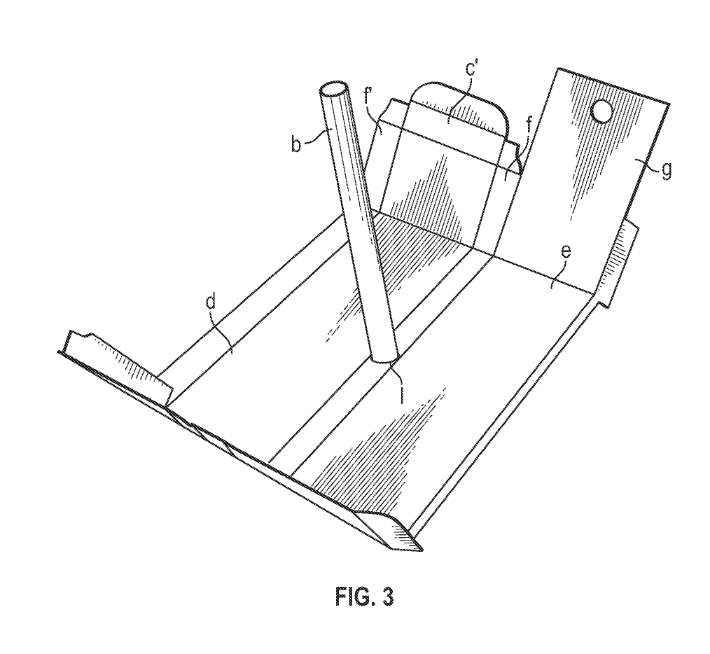

The present invention extends to a container (a) for therapeutic candles (b) [FIG. 1] and a system for using the container (a) to hold the therapeutic candles (b) while in use.

The container (a) comprises a cut sheet box formed from a suitable paper or card stock sheet material. The thickness of such sheet material will depend on the type of material selected. If paper is selected, such paper may be chipboard, coated recycled board, solid bleached sulfate, with a caliper of between 0.008-0.024 inches, and basis weight of between 50# and 90#. Preferably the paper selected would be solid bleached sulfate, with a caliper of 0.012 to 0.018 inches, and a basis weight of between 55# and 70#. Most preferably, the paper would be solid bleached sulfate with a caliper of 0.016 inches and a basis weight of 61#.

The preferred embodiment of the present invention has an uncut length of not more than 20 inches, preferably 18 inches, more preferably 17 9/32 inches in the longest dimension; cut length of between not less than 5 and not more than 19 inches, preferably between 8 and 17 inches, more preferably 16 9/32 inches in length.

The preferred embodiment of the present invention comprises a finished container (a) having four long side panels and two closeable end panels (c) [FIG. 2]. The long sides comprise a front panel (d), a back panel (e), a first side panel (f) and a second side panel (f) formed about a longitudinal axis [FIG. 2]. The back panel (e) may optionally be cut to extend further than the front side, either longitudinally with, or laterally from, the longitudinal axis to create a tab (g) that may be perforated (h) [FIG. 2] to allow the container (a) to be hung in retail displays in either a portrait or landscape orientation, respectively. Additional material is shown in FIG. 2 along the back panel. That additional material is only used to receive adhesive and to close the container when placed in contact with the second side panel (f′).

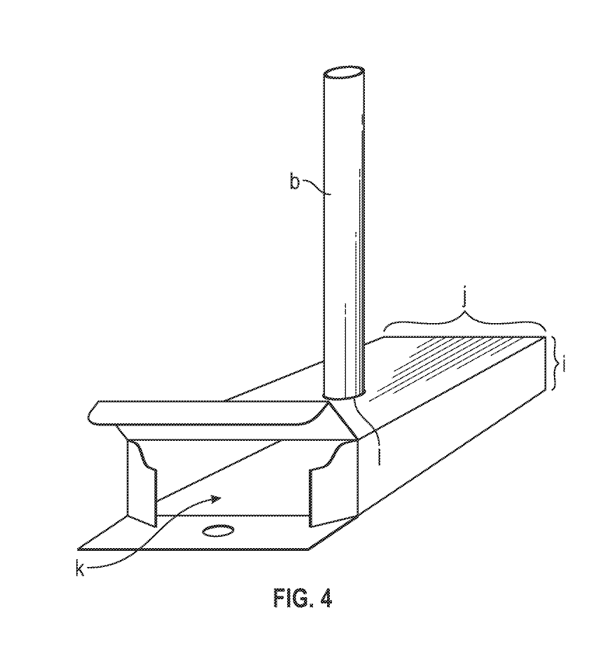

The depth (i) of the container (a) from the front panel (d) to the back panel (e), and its width (j) between a first side panel (f) and a second side panel (f′) is not less than ⅜ inch, preferably ⅝ inch, to form a chamber whose cross section area (h) [FIG. 4] is capable of receiving at least one candle (b), with a diameter not less than ⅜ inch, within the container (a).

The distance between any long panel and its opposing panel may be increased by increasing the width of the adjacent side panels to accommodate additional candles (b), side by side. In an embodiment of the present invention of a container (a) intended to contain two candles (b), the front (d) and back long panels (e) are wider, being at least one inch (1″) wide, and preferably 1¾ inches in width (j). In another iteration of the preferred embodiment, intended to hold four candles (b) side-by-side, the width (j) of the front (d) and back panels (e) is at least 1.5 inches, and preferably 2⅜ inches.

In an alternative embodiment of the present invention intended to hold four candles (b), the box could be equally deep (i) and wide (j) to receive the candles (b) arranged in pairs, front to back. In this embodiment the long sides would have width (j) equal to depth (i), of at least 1 inch and preferably 1¾ inches.

In a preferred embodiment of the present invention, at least one long side of the container (a) is prepared with a punch, perforations or relief cuts or combination thereof defining a hole (1), which when depressed or removed creates a hole to insertably receive and frictionally retain a candle (b) when in use. The dimension of the hole created in the container (a) of the preferred embodiment is between ¼ and ¾ inches in diameter, preferably between ⅜ and 9/16 inches, and more preferably 15/32 inches in diameter.

The therapeutic uses of the candles (b) in a kit of the present invention are facilitated by providing candles (b) in a variety of selectable combinations of wax and aromatic fragrance formulation. The waxes may be selected from the group comprising paraffin or beeswax. The aromatic fragrance formulations may be selected from the group consisting of plain (unscented), scented, herbal and lavender.

It is a further feature of the preferred embodiment that the container (a) be constructed with adhesive selected to be strong enough to form the box, but weak enough that the adhered panels can be easily separated without destroying the box.

Accordingly, implementations of the present invention provide a number of configurations for creating a box capable of storing candles (b) and being capable of reconfiguration as a candle holder, together with a variety of therapeutic candles (b). One will appreciate that the concepts disclosed herein can be varied to create a number of candle holder configurations. As previously mentioned, for example, a manufacturer can use any number of holes, singly or in combination to hold a candle or candles (b) while in use. Furthermore, a manufacturer can pre-stress the box to be deformed into desirable shapes and geometries to further enhance stability when in use as a candle holder. Still further, the manufacturer can apply treatments to render the box flame retardant as desirable or as required.

The present invention, therefore, may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A package for therapeutic candles comprising:
a container formed from a cut sheet material which when folded forms a six sided box comprising a front panel, a back panel, a first side panel, a second side panel, a top panel and a bottom panel;
wherein said container is at least 4 inches in length, and having a cross sectional area capable of holding a cylindrical candle of at least ⅜ inches in diameter;
wherein at least one panel has been prepared with an opening of a size selected to frictionally retain a candle when inserted therein for use.

2. A package of claim 1 wherein the box may be deconstructed and laid relatively flat to capture falling ash or melted wax.

3. A package of claim 1 wherein the opening to retain the candle is sized between ¼ and ¾ inches in diameter, preferably between ⅜ and 9/16 inches, and more preferably 15/32 inches in diameter.

4. A package of claim 1 wherein the sheet material is selected to be resilient to repetitive handling and deformation.

5. A package of claim 1 wherein the sheet material is selected to be biodegradable.

6. A package of claim 1 wherein the finished container possesses flame resistant qualities.

7. A package of claim 6 wherein the flame resistant qualities are obtained by using flame resistant sheet material.

8. A package of claim 6 wherein the flame resistant qualities are obtained by treating the container.

9. A package of claim 1 wherein the container is prepared with stress relief in at least one surface to facilitate reconfiguration into alternate shapes to enhance its usability as a candle holder.

10. A kit of therapeutic candles and candle holder comprising:
at least one therapeutic candle;
a container formed from a cut sheet material which when folded forms a six sided box having four long side panels, and a top and a bottom panel;
wherein said container is at least 4 inches in length, and having a cross sectional area capable of holding a cylindrical therapeutic candle of at least ⅜ inches in diameter;
wherein at least one panel has been prepared with an opening of a size selected to frictionally retain a therapeutic candle when inserted therein for use.

11. A kit of claim 10 wherein the at least one therapeutic candles is selected from the group consisting of paraffin or beeswax.

12. A kit of claim 11 wherein the at least one therapeutic candles is manufactured of a variety selected from the group consisting of plain, scented, herbal or lavender.

13. A kit of claim 10 wherein the container is constructed using adhesive selected for its bond strength to allow the container to be deconstructed without destroying the container.
